(19) United States
(12) Patent Application Publication
(10) Pub. No.: US 2009/0197123 A1
(43) Pub. Date: Aug. 6, 2009

(54) Nano-Scaled Reactor for High Pressure and High Temperature Chemical Reactions and Chemical Ordering

(75) Inventors: Joachim W. Ahner, Pittsburgh, PA (US); Nisha Shukla, Pittsburgh, PA (US); Dieter Weller, Gibsonia, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/342,455

(22) Filed: Dec. 23, 2008

Related U.S. Application Data
(62) Division of application No. 10/982,471, filed on Nov. 5, 2004, now abandoned.

(51) Int. Cl. G11B 5/66; B05D 3/02; B05D 5/00; G11B 5/706

(52) U.S. Cl. 428/830; 427/372.2; 427/550; 427/130; 428/846

(57) ABSTRACT

A storage device includes a storage medium, a controller and a read/write head. The storage medium includes a substrate with a plurality of nano-structures arranged in an ordered pattern on a surface of the substrate. The controller is coupled to the storage medium. The controller has a read structure that extends over the substrate and a positioner adapted to adjust a position of the read structure relative to the substrate. The read/write head is mounted on the read structure and positioned over the substrate during operation. The read/write head is adapted to read and to write information to and from the plurality of nano-structures.

### CROSS-REFERENCE TO RELATED APPLICATION

None.

### FIELD OF THE INVENTION

The present invention relates to nano-scaled device fabrication, more particularly, to a system and method for high pressure and high temperature chemical reactions and chemical ordering in nano-scaled devices.

### BACKGROUND OF THE INVENTION

In general, the ability to store a given amount of information on a storage device (hard disc drive or HDD, magnetic random access memory or MRAM, flash memory, or any other storage media) is driven largely by the areal density of the storage device. The term “areal density” refers to the size and the spacing of information bits on a storage media. Increasing the areal density generally refers to a process of making the information bits smaller and more closely spaced.

At a certain density, laws of physics (specifically Boltzman's Second Law of Thermodynamics, which is sometimes referred to as the “superparamagnetic effect”) indicate that magnetically recorded zeros will become ones and ones will become zeros, causing a near instantaneous degradation of “data” into useless information. It is therefore a goal of the storage industry to increase the areal density of the storage media while avoiding the deleterious effects of superparamagnetism.

Self-organized magnetic arrays (SOMA) make use of iron-platinum particles dispersed in a solvent which, after being subjected to an evaporation and annealing process, transform themselves from a chaotic superparamagnetic state into a patterned, readable ferromagnetic state. These SOMAs may then be deposited in sectors on the recording media. By recording one bit per particle, it is theorized that an areal density of up to 50 Terabits per square inch (TB/in²) might be obtained without experiencing the superparamagnetic effect.

Like SOMAs, many chemical reactions and chemical ordering processes require high pressure and high temperature environments for fabrication. Conventionally, specialized high-pressure chambers are utilized for processes requiring high pressure/high temperature environments. Depending on the chemical composition of the reactant and the required process pressure and temperature, these chambers may require special construction material and safety features, which can increase the process costs dramatically. Additionally, in many cases, the end product of the chemical reaction and chemical ordering processes requires further processing.

When iron-platinum particles are used for high density recording media, a major challenge is to tightly control spacing, shape, and arrangement of nano-particle structures at temperatures required to promote chemical ordering. The term “sintering” refers to a process by which the composition is heated to a temperature that is below the melting point of the composition but which causes the particles within the composition to agglomerate into larger masses. In high density storage media, the high temperature and pressure process, which converts the internal particle structure of the iron-platinum layer into a chemically ordered state, also leads to pronounced sintering of the deposited composition, meaning that the spacing, shape and arrangement of the nano-particle structures is not well controlled. As a result, the orientation of the internal particle structures and, consequently, the areal density of the storage media are less than optimal.

Several nano-structure fabrication processes have been suggested, including Silicon-precipitation techniques (e.g. ion implantation and the deposition of Silicon-rich oxide layers), aerosol deposition, direct growth, thermal oxidation of Silicon and Germanium, and wet etching of poly-silicon substrate along grain boundaries. Conventionally, one method for avoiding sintering involves performing the chemical ordering in a high temperature/high pressure environment of surfactant or solvent. Pressures of up to 50 atm could occur, and high pressure processing chambers are required. Currently, only macroscopically sized high pressure cells are available, which are expensive and which make processing more complicated. Specifically, subsequent to the high pressure/temperature treatment steps, the nano-particles need further processing steps, such as self-organization in thin film structures and magnetically orienting onto the substrate. Thus, there is an on-going need for improvements in the manufacture high density storage media. Embodiments of the present invention provide solutions to these and other problems, and offer other advantages over the prior art.

### SUMMARY OF THE INVENTION

A storage device includes a storage medium, a controller and a read/write head. The storage medium includes a substrate with a plurality of nano-structures arranged in an ordered pattern on a surface of the substrate. The controller is coupled to the storage medium. The controller has a read structure that extends over the substrate and a positioner adapted to adjust a position of the read structure relative to the substrate. The read/write head is mounted on the read structure and positioned over the substrate during operation. The read/write head is adapted to read and to write information to and from the plurality of nano-structures.

In one embodiment, a method for producing a substrate having ordered nano-particles is described. A plurality of depressions disposed in a surface of the substrate are filled with nano-particles. A cover layer is deposited over the surface and the filled depressions to form closed cells. The closed cells are heated. A field is applied to the heated closed cells to orient the nano-particles in a direction relative to the field.

In another embodiment, a magnetic storage medium is described. A substrate has a surface with a plurality of recesses disposed on the surface. A magnetic nano-particle deposit is disposed in each recess and configured for magnetically storing information. A lubricant layer is disposed over the surface and over each nano-particle deposit.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIG. 2 is simplified block diagram of a nano-scaled reactor according to an embodiment of the present invention.

FIG. 3 is a top plan view of a high-pressure nano-cell array design for use with high temperature chemical ordering of patterned thin films according to an embodiment of the present invention.

FIGS. 4A and 4B are a cross-sectional views of the high-pressure nano-cell array of FIG. 3 taken along lines 4-4 after deposition of the capping layer.

FIG. 5 is a simplified schematic flow diagram of process steps for producing a high density recording media according to an embodiment of the present invention.

FIG. 6A is a high resolution image of a nano-particle sample of Iron-Platinum deposition on a silicon substrate that was annealed without a capping layer according to a conventional process.

FIG. 6B is a high resolution image of a nano-particle sample of Iron-Platinum deposition on a silicon substrate that was annealed with the capping layer according to an embodiment of the present invention.

### DETAILED DESCRIPTION OF ILLUSTRATIVE EMBODIMENTS

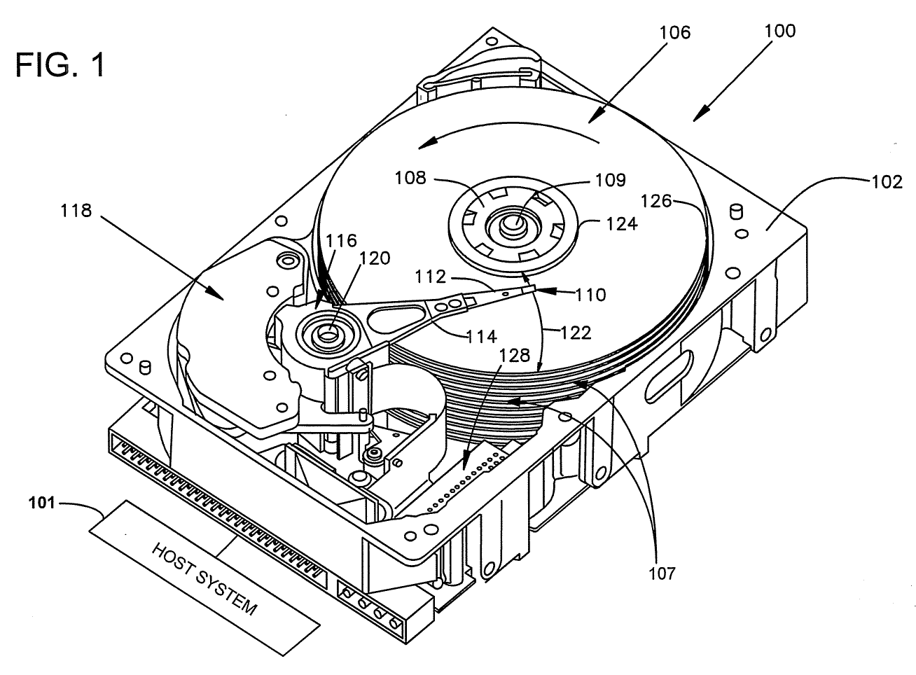

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface.

In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an accurate path 122 between a disc inner diameter 124 and a disc outer diameter 126. Voice coil motor 118 is driven by servo electronics 130 based on signals generated by heads 110 and a host computer (not shown).

Instead of utilizing conventional macroscopic high pressure cells, the present invention utilizes a nano-scaled system consisting of depressions (sometimes referred to as “recesses” or “trenches”) fabricated into the substrate surface. The fabrication of the depressions can be done at mass production using graphic methods including etching. The depressions may then be filled with the reactant and subsequently capped by deposition of a continuous layer of material. When heating the capped cell, the pressure inside of the cell increases to a value given by the vapor pressure of the enclosed components.

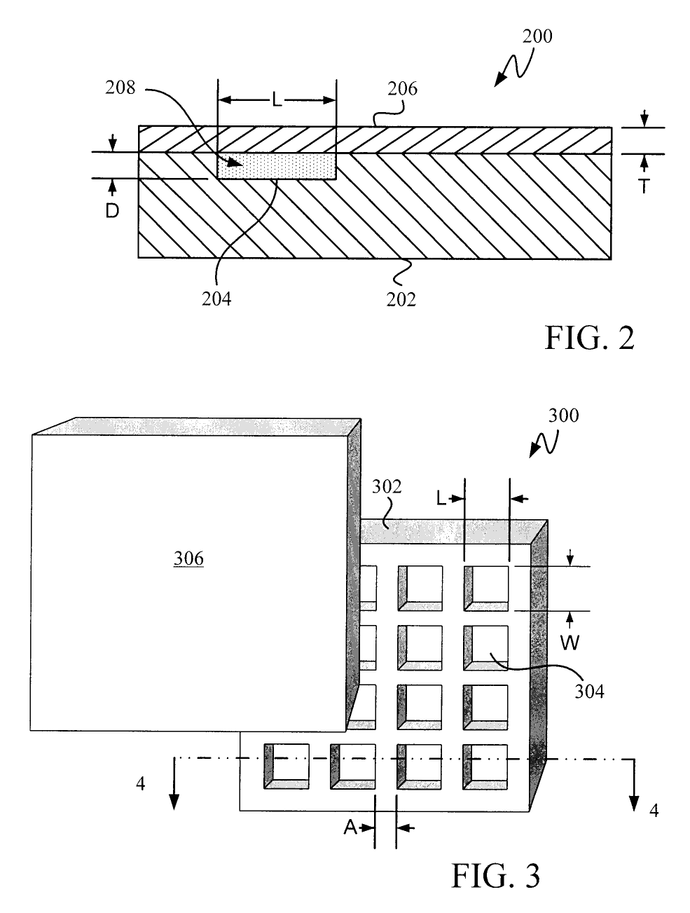

FIG. 2 is simplified block diagram of a nano-scaled reactor 200 according to an embodiment of the present invention. The nano-scaled reactor 200 includes a substrate 202 in which a depression 204 is defined. The substrate 200 is coated by a capping layer 206, which encloses the depression 204 to form cell 208. The cell 208 has a depth (D) and a length (L). The capping layer 206 has a thickness (T). In general, the required pressure resistance of the cell 208 defines the minimum aspect ratio of the capping layer thickness T and depression length L. In a first approximation, a minimum thickness T of the capping layer 206 scales linearly with a size of the cell 208 (in quadratic cross-section) according to the following equation:

T≧C\sqrt{PL²} Equation 1

where C is a material constant.

If the size of the cell 208 is in a nanometer-size range, the thickness (T) of the capping layer 206 preferably falls in a nanometer size range and can be readily adjusted to withstand extremely high pressures by simply depositing additional material to make the thickness (T) greater.

Prior to deposition of the capping layer 206, the depression 204 is filled with reactant. After deposition of the capping layer 206, the pressure of the reactant within the cell 208 increases with the temperature. Once the desired temperature and pressure is achieved, the reactants in the cell 208 may be exposed to a magnetic or electrical field in order to control field-induced ordering/alignment of the compound structures.

In general, the choice of materials for the substrate 202 and the capping layer 206 depends on the chemical reactivity and physical properties of the reactant compounds. In one embodiment, the substrate 202 and the capping layer 206 are formed from the same material. In a preferred embodiment, the substrate 202 and the capping layer 206 are formed from different materials. In one embodiment, the reactant may be, for example, an iron-platinum (FePt) nano-particle solution, which is prepared utilizing a combination of oelic acid and oleyl amine to stabilize the monodisperse FePt colloids and to prevent oxidation. In such an embodiment, the substrate 202 may be formed from a thin film recording media having a base formed from an Aluminum-Magnesium alloy, which is plated with an amorphous layer of Nickel-Phosphorus, which is in turn coated with a layer of Chromium and a thin magnetic film (typically a cobalt alloy with chromium and coercivity-controlling elements such as Platinum and/or Tantalum). The capping layer 206 is formed from a material that can be bonded with the thin magnetic film layer of the substrate with sufficient bonding strength to withstand pressures resulting from annealing temperatures up to 650 degrees Celsius. In one embodiment, the capping layer 206 is formed from carbon.

Possible deposition methods for the capping layer 206 include sputter deposition, molecular beam epitaxy, laser induced deposition, chemical vapor deposition, electroplating, and the like. In general, any technique for depositing an appropriately sized capping layer 206 onto an etched or otherwise processed substrate having depressions 204 in a nanometer size range is possible.

It should be understood that the choice of materials for the substrate 202 and capping layer 206 is very flexible. In general, the choice depends on the chemical reactivity and physical properties of the reactant compounds.

FIG. 3 is a top plan view of a portion of a high-pressure nano-cell array 200 for use with high temperature chemical ordering of patterned thin films in the as-deposited state according to an embodiment of the present invention. Array 300 is comprised of a plurality of tetragonal cells 304 of length (L), width (W), and depth (D), which are formed on substrate 302. Capping layer 306 is shown removed from the substrate 302, thereby exposing the tetragonal cells 304.

In one embodiment, the cells 304 are substantially square and substantially equally sized and spaced in a symmetric pattern. In a preferred embodiment, the length (L) and width (W) of each cell 304 is approximately equal, and each cell 304 has approximately the same dimensions as the other cells 304. Additionally, the wall thickness (A) separating neighboring cells 304 or depressions is approximately the equal. The capping layer 306 has a thickness (T), which is substantially similar to the wall thickness (A).

As previously discussed, the required pressure resistance of the cell 304 defines the minimum aspect ratio of the capping layer thickness (T) and depression dimensions (length L and width W). In a first approximation, a minimum thickness T of the capping layer 306 scales linearly with a size of the cell 308 (in quadratic cross-section) according to the following equation:

T≧C\sqrt{PL²} (Equation 1)

where C is a material constant and where the length L equals width W.

If the size of the cell 304 is in a nanometer-size range, the thickness (T) of the capping layer 306 preferably falls in a nanometer size range and can be readily adjusted to withstand extremely high pressures by simply depositing additional material to make the thickness (T) greater.

In general, the dimensions of thickness (T) and the size of the cells scale with the maximum pressure and the minimum affordable thickness of the cover layer. In most thin-film and recording applications, it is desirable to minimize the thickness of the cover layer. Thus, assuming that the cover layer has a minimum affordable thickness, the cell size is calculated using equation 1 above. In a first approximation, the required minimum thickness of the cover layer scales linearly with the cell-size. For example, if the temperature/pressure/material requirements require a cell size ten times larger than the cover layer thickness and the cover layer thickness has a minimum affordable thickness of 10 nm, each cell has a quadratic cell size of 100 nm×100 nm. In a cell array, the wall thickness separating the cells is less important, in part, because the pressures from adjacent cells tend to cancel each other out. Thus, the cells spacing can be much thinner (for example, approximately 10 nm). In an isolated cell or for the outside (exposed) walls of an array of cells, the thickness may be greater. In one embodiment, the exposed cell walls have a thickness approximately equal to the thickness of the cover layer.

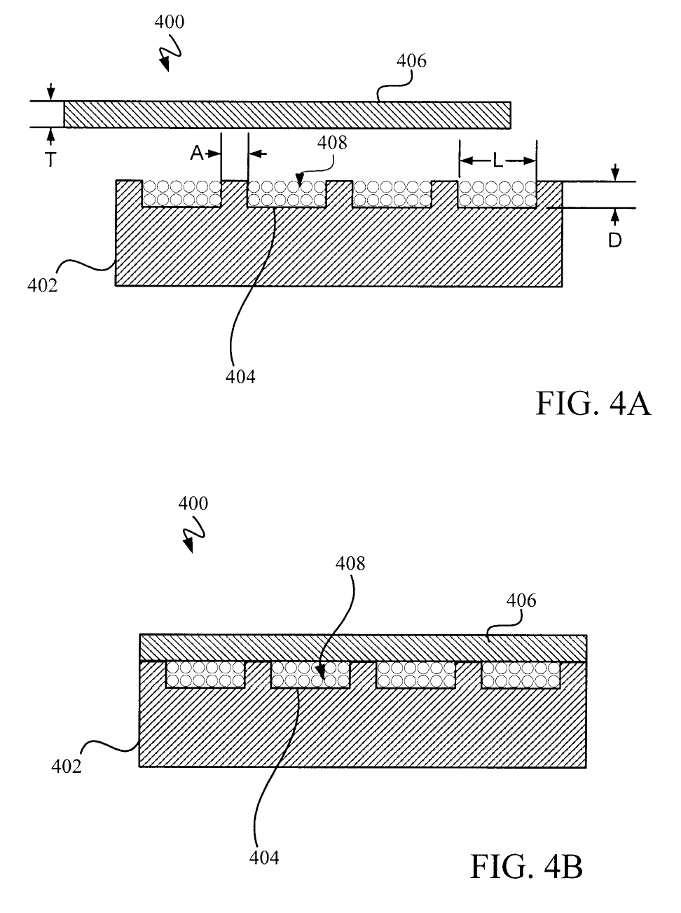

FIGS. 4A and 4B illustrate a cross-sectional view of the array 300 taken along line 4-4 in FIG. 3. In FIG. 4A, the nano-cell array structure 400 includes a substrate 402 formed with depressions or cells 404. A capping layer 406 separated from the substrate 402 is shown. Additionally, the cells 404 are shown to be filled with a reactant 408. Each cell has a length (L) and a depth (D). The wall thicknesses (A) separating adjacent cells 404 are approximately equal. Finally, the capping layer 406 is indicated to have a thickness (T). In one embodiment, the thickness (T) of the capping layer 406 and the wall thickness (A) separating adjacent cells is approximately the same.

In general, it should be understood that the reactant 408 is comprised of a plurality of nano-particles suspended or otherwise combined in solution. The nano-particles generally have substantially similar sizes, meaning that their diameters and other dimensions are substantially similar. Additionally, the solution maintains the nano-particles in a substantially uniformly spaced-apart relationship, which is maintained within each depression of the array of depressions.

In FIG. 4B, the array of depressions 404 is closed by capping layer 406 to form closed cells 404. The connection between the capping layer 406 and the substrate 402 is characterized by an adhesion coefficient (V) and the wall thickness (A). Adhesion is the strength of the bond of the coating to the substrate, and the adhesion coefficient (V) is a value that can be used to characterize the strength of the bond.

In one embodiment for processing iron-platinum nano-particles, the substrate 402 is formed from silicon with fabricated tetragonal cells 404 having lengths of 200 nanometers. The distance between tetragonal cells 404 is approximately 20 nanometers (e.g. the wall thickness A is 20 nm), and the capping layer 406 is formed of a carbon material having a thickness of approximately 20 nm. According to equation 1 above, a design of this configuration can withstand pressures (P) in excess of 50 atmospheres.

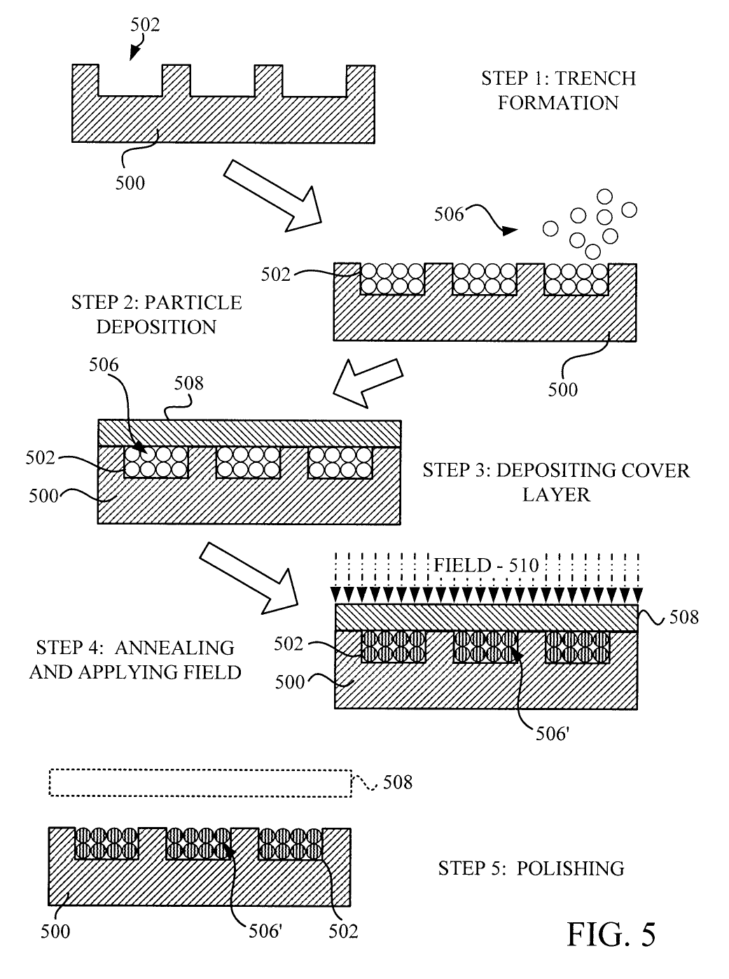

FIG. 5 is a simplified schematic diagram of process steps for producing a high density recording media according to an embodiment of the present invention. Depressions 502 are established on a surface of a substrate 500 by any one of a variety of techniques known in the art. (step 1) In a preferred embodiment, the depressions 502 are formed in the substrate 500 using standard electronbeam lithography.

The depressions 502 are filled with nano-particles 506 (step 2). In a preferred embodiment, the nano-particles are chemically synthesized FePt nano-particles. Typically, the nano-particles 506 are deposited together with a surfactant to assist in even flow of the nano-particles 506 over the surface of the etched substrate 500.

A capping or cover layer 508 is deposited over the depressions 502 and the nano-particles 506 within the depressions 502. (step 3). In a preferred embodiment, the cover layer 508 is formed from carbon and is sputter deposited onto the substrate to form closed cells.

The sample is then exposed to heat in order to anneal the sample. Preferably, the sample is heated to a sufficient temperature (elevated temperature) to initiate a transformation from face-centered-cubic to face-centered-tetragonal phase FePt nano-particles. In one embodiment, the sample is heated to 650 degrees Celsius or higher. Raising the temperature of the sample also increases the pressure of the nano-particles 506 in each depression 502. The nano-particles 506 are still separated by surfactant in solution and are mobile. An external magnetic or electric field 510 is applied in order to promote magnetic orientation/alignment of the nano-particles 506 into aligned particles 506′. (step 4). In one embodiment, electrodes are embedded in the top and bottom of the substrate for use in applying an electric field.

After the sample cools, the cover layer 508 is removed mechanically. (step 5). In one embodiment, the mechanical removal process involves polishing. In another embodiment, the cover layer 508 is removed via an etching process. In a preferred embodiment, the field (magnetic or electric) is applied during the heating process as well as during a cooling down period (which typically occurs between the annealing step and the mechanical removal step.

The resulting patterned magnetic recording media displays atomic ordering with very good local coherence and ordering, and with minimal sintering. The size of the nano-particles and the shape and precision of the depressions may negatively impact nanoparticle orientation. In a preferred embodiment, a silicon template is employed with electron beam lithography to achieve sharp depression walls, and nano-particles of approximately 4 nm diameter are utilized. Larger sized particles may also be utilized, but data density may be reduced accordingly. Testing has indicated that approximately 90% of the FePt nano-particles achieve a preferred orientation in terms of magnetization using the technique described above. In terms of data density, the present invention makes it possible to achieve data densities approaching 40 Terrabits per square inch on the recording media.

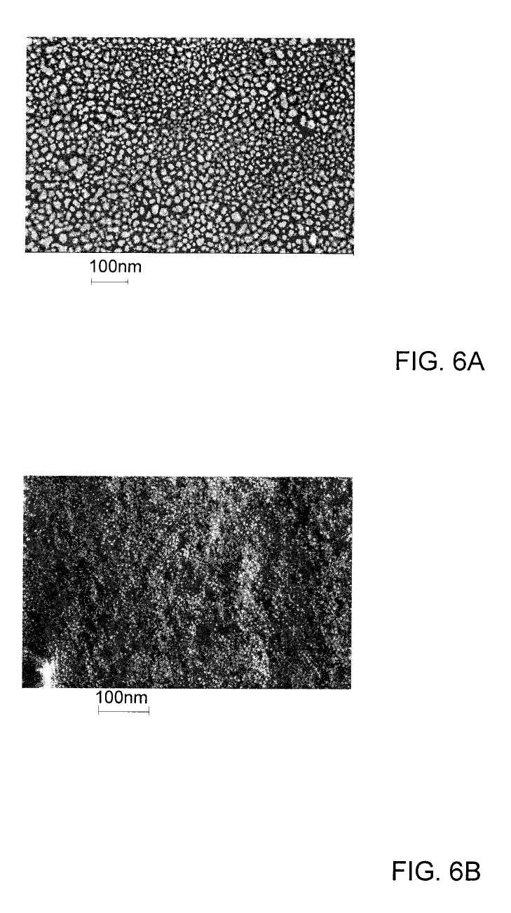

FIGS. 6A and 6B show magnified photographs of the surfaces of two different FePt nano-particle samples. In both cases, chemically synthesized nano-particles from identical solutions were deposited on silicon substrates and subsequently annealed to 650° C. for 30 minutes. The nanoparticle sample shown in FIG. 6A is a substrate produced according to prior art techniques, where the depressions were not capped during annealing. As previously mentioned, sintering refers to the agglomeration of particles heated to a temperature below a melting point of the particles. The photograph (presented at a magnification of 193,550×) of the sample shows pronounced sintering.

FIG. 6B shows the surface of a second substrate after removal of the cover layer according to an embodiment of the present invention, such as the technique described in FIG. 5. Prior to annealing and exposing the substrate to a field, a cover layer was deposited on the substrate over the filled depressions. In this embodiment, the cover layer was a 20 nanometer-thick carbon layer. After annealing and application of a field, the carbon layer was mechanically removed to expose the FePt nano-particles. At a magnification of 187,040×, the surface has little or no particle agglomeration. In general, the size and size distribution of nano-particles remains unchanged in comparison to the size and distribution of unannealed particles at the deposition phase.

A high density storage media requires high temperatures and pressures to achieve proper alignment of the nano-particles. While the present invention has largely been described with respect to recording densities, the technique of the present invention has applications outside of storage systems. For example, the technique of the present invention may be utilized to produce any type of system for which atomic ordering is required to achieve the preferred orientation in terms of magnetization. The technique of utilizing a cover layer to create nano-sized pressure cells for the purpose of atomic ordering may be useful in a variety of technologies, including biotechnology, solar cell technology, energy generation technologies, coating technologies, nano-battery technologies, and numerous other industries.

While the present invention describes the depressions in the nano-cell array as being “square” or substantially equilateral, other shapes of depressions may also be used. In a preferred embodiment, square or hexagonal shapes provide a preferred packing density to achieve the highest density recording media. However, in other embodiments and for other uses, a differently shaped depression may be desirable to achieve particular chemical or mechanical effects. Additionally, in self-organized magnetic arrays (SOMAs), the depressions themselves may be used to determine the coherent length of ordered nano-particles in 2-dimensions.

The present invention utilizes an array of cells formed in a substrate, a plurality of nano-particles filling the array of cells, and a cover layer formed over the array and the nano-particles to produce a patterned recording surface on the substrate. Because the nano-particles are secured in cells during the annealing and orientation process, sintering is minimized. Removal of the cover layer after annealing and particle alignment results in a near perfectly oriented, patterned layer which may be used for high density data storage.

In general, though the method of the present invention has been described to include a cover layer removal step, in some instances the cover layer may be left in place after annealing. For example, in a magnetic storage application, the cover layer could theoretically be used as an overcoat. In an optical application (solar cell, photonic crystal application), if the cover layer is transparent, the top layer can be left in place. For battery applications, the layer might be left in place to protect the active material when temperature and pressure rises, such as during discharge. Typically, pressure and temperature rise during discharge (especially for higher discharge currents), which presents a problem in some battery applications. By embedding material in the nano-pressure cells, it is possible to operate batteries at much higher temperatures, where chemical reactions occur at an increased rate and where much higher pressures can be tolerated.

While the present disclosure has not described in detail all of the possible applications of the present invention, it should be understood that the nano-structure of the high pressure system enables higher operating temperatures and pressures, and therefore higher efficiencies. For all applications where high pressure and high temperature are needed during operation, the cover layer may be left in place.

In one embodiment, a magnetic recording media is produced via the method of the present invention wherein the cover layer is polished and left as an overcoat. In a preferred embodiment, the cover layer is removed via a polishing or other removal process to expose the array of cells. The surface is then coated with an overcoat.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the nano-structured system while maintaining substantially the same functionality without departing from the scope and spirit of the present invention. In addition, although the preferred embodiment described herein is directed to a nano-scaled reactor for producing chemically ordered patterned recording media, it will be appreciated by those skilled in the art that the teachings of the present invention can be applied to various industries and products that require high pressure and high temperature chemical reactions and chemical reordering, without departing from the scope and spirit of the present invention.

1-21. (canceled)

22. A method comprising:
filling a plurality of depressions disposed in a surface of a substrate with a reactant solution comprising a plurality of nano-particles;
depositing a cover layer over the surface and the plurality of depressions to form a plurality of closed nano-scaled reactors;
heating the plurality of closed nano-scaled reactors; and
applying a field to the plurality of closed nano-scaled reactors to orient the plurality of nano-particles in a direction relative to the field.

23. The method of claim 22, wherein applying the field comprises applying a magnetic field to align the plurality of nano-particles.

24. The method of claim 22, wherein applying the field comprises applying an electrical field to align the plurality of nano-particles.

25. The method of claim 22, wherein the plurality of nano-particles comprise Iron-Platinum (Fe—Pt) particles.

26. The method of claim 22, wherein a thickness of the cover layer is related to a pressure applied to the reactant solution during heating.

27. The method of claim 22, wherein the substrate is formed from a first material and wherein the cover layer is formed from a second material.

28. The method of claim 27, wherein the first material comprises:
a first layer formed from a Aluminum-Magnesium alloy;
a second layer formed from a Nickel-Phosphorous alloy;
a third layer formed from Chromium; and
a fourth layer comprising a thin magnetic film.

29. The method of claim 28, wherein the second material comprises a carbon material adapted to bond with the thin magnetic film layer with sufficient bonding strength to withstand pressures resulting from heating the plurality of nano-scaled reactors.

30. The method of claim 22, wherein heating the plurality of nano-scaled reactors comprises elevating a temperature of each of the plurality of nano-scaled reactors to an annealing temperature to initiate transformation of the plurality of nano-particles from face-centered-cubic phase nano-particles to face-centered-tetragonal phase nano-particles.

31. The method of claim 30, further comprising removing at least a portion of the cover layer after the field is applied.

32. A data storage medium comprising:
a substrate having a surface;
a plurality of recesses disposed on the surface in an ordered pattern;
a nano-particle deposit disposed in each recess to store data, the magnetic nano-particle deposit having a controlled particle alignment; and
a cover layer formed from a carbon material deposited over the surface and over each magnetic nano-particle deposit to form a plurality of closed cells.

33. The data storage medium of claim 32, wherein each recess of the plurality of recesses is separated from adjacent recesses by at least one wall having a wall thickness that is less than a cover layer thickness associated with the cover layer.

34. The data storage medium of claim 33, wherein the substrate is formed from silicon, and wherein the cover layer comprises a carbon material.

35. The data storage medium of claim 32, wherein the substrate comprises:
a first layer formed from a Aluminum-Magnesium alloy;
a second layer formed from a Nickel-Phosphorous alloy;
a third layer formed from Chromium; and
a fourth layer comprising a thin magnetic film.

36. The data storage medium of claim 35, wherein the cover layer is bonded to the thin magnetic film layer with sufficient bonding strength to withstand pressures resulting from heating of the plurality of closed cells during fabrication.

37. The data storage medium of claim 36, wherein the cover layer comprises a cobalt alloy with Chromium and coercivity-controlling elements including at least one of one of Platinum and Tantalum nano-particles.

38. A data storage medium comprising:
a substrate including a plurality of recesses disposed in an ordered pattern on a surface of the substrate, each recess of the plurality of recesses separated from adjacent recesses by at least one side wall having a first thickness;
a plurality of nano-particle deposits disposed within the plurality of recesses, each nano-particle deposit having a controlled particle alignment and configured to store data; and
a cover layer having a second thickness disposed over the surface and over each magnetic nano-particle deposit to form a plurality of closed cells;
wherein the second thickness is greater than or equal to the first thickness.

39. The data storage medium of claim 38, wherein the cover layer is configured to bond to the substrate with sufficient bonding strength to withstand pressures due to heating of the substrate during annealing.

40. The data storage medium of claim 38, wherein the cover layer comprises a carbon layer.

41. The data storage medium of claim 38, wherein the plurality of nano-particle deposits comprise Iron-Platinum (Fe—Pt) nano-particles.

42. The data storage medium of claim 38, wherein a thickness of the cover layer is related to a size of at least one recess of the plurality of recesses.

43. The data storage medium of claim 38, wherein each recess of the plurality of recesses comprises a length of approximately 200 nm, wherein the first thickness is approximately 20 nm, and wherein the second thickness is approximately 20 nm.
